(19) United States
(12) Patent Application Publication
(10) Pub. No.: US 2006/0155061 A1
(43) Pub. Date: Jul. 13, 2006

(54) Adhesive for a polarizer

(75) Inventors: Chih-Chiang Liao, Ping Chen City (TW); Yao-Chung Cheng, Ping Chen City (TW); Tien-Hsieh Chen, Ping Chen City (TW); Chia-Lin Hsieh, Chungli City (TW)

Correspondence Address: BIRCH STEWART KOLASCH & BIRCH, PO BOX 747, FALLS CHURCH, VA, 22040-0747, US

(73) Assignee: Optimax Technology Corporation

(21) Appl. No.: 11/166,100

(22) Filed: Jun. 27, 2005

(30) Foreign Application Priority Data
Jan. 11, 2005 (TW) 94100779

(51) Int. Cl. C08L 29/04; C04B 24/26

(52) U.S. Cl. 525/58; 524/803

(57) ABSTRACT

An adhesive for a polarizer is described, and is made of a solution of polyvinyl alcohol and an aldehyde. A catalyst may be further added therein. Additionally, glyoxal may be selected as the aldehyde, with a content preferably around 0.01% to around 5% by weight. On the other hand, the concentration of the polyvinyl alcohol aqueous solution is preferably about 1% to about 10% by weight.

### RELATED APPLICATIONS

The present application is based on, and claims priority from, Taiwan Application Serial Number 94100779, filed Jan. 11, 2005, the disclosure of which is hereby incorporated by reference herein in its entirety.

### BACKGROUND

1. Field of Invention

The present invention relates to an adhesive for a polarizer. More particularly, the present invention relates to an adhesive for a polarizer fabrication.

2. Description of Related Art

As a result of the burgeoning of photoelectric technology and the act of digitization throughout the world, the market for liquid crystal displays (LCD) is rising and flourishing. Because of advantages of high resolution, small size, light weight, low driving voltage, and low power consumption, liquid crystal displays are commonly applied to consumption communication facilities or electronic products, such as a personal digital assistant, (PDA), a cell phone, a digital video camera, a notebook, a personal computer monitor, a car navigator, or an overhead TV projector, and are gradually replacing cathode ray tubes (CRT) as mainstream displays.

A polarizer is an important component of a liquid crystal display (LCD), which converts natural light to polarized light and controls the brightness of the LCD by twisting liquid crystal molecules. FIG. 1 is a schematic cross-sectional view of the structure of a polarizer. A polarizer is composed of several optical films, which control the polarization mechanism of lights. A polyvinyl alcohol film (PVA) 100 containing a dichroic material is generally used as a polarization substrate. Because the PVA film with dichroic materials has a decreased mechanical property and is crumbly after being extended into a film, a tri-acetyl cellulose (TAC) film is typically applied on the edges of the PVA film as reinforcement. A pressure sensitive adhesive 140, a releasing film 160, and a protective film 180 are applied on the PVA film in sequence for storage and protection. Typically, the protective film 180 is made of polyethylene (PE), and the releasing film is made of polyethylene terephthalate (PET). A wide-angle film may be applied on the polarizer as a secondary protection layer for a large LCD.

Prior to polarizer fabrication, PVA and TAC films may be treated with various processes, such as extending, dyeing, and drying for the PVA film 100, and etching, water-washing, and drying for the TAC film. The treated PVA and TAC film then are adhered with a gel or glue. However, adhesion of conventional glue or gels usually suffer from temperature and humidity. Thus, producing a polarizer with conventional glue or gels may cause poor weather resistance, and the shrinkage or detachment of the PVA film, and further lead to a decreased yield and poor quality of the polarizer.

### SUMMARY

It is therefore an aspect of the present invention to provide an adhesive to improve the adhesion between a polyvinyl alcohol (PVA) film and a tri-acetyl cellulose (TAC) film and further improve the yield and quality of the polarizer.

In accordance with the foregoing and other aspects of the present invention, an adhesive with enhanced heat and water resistance is provided, which improves the yield of the polarizer by providing a better adhesion between PVA film and TAC film. In addition, the weather resistance of the polarizer is also improved by using the adhesive with enhanced water and heat resistance.

In accordance with a preferred embodiment of the present invention, a method for producing an adhesive of the invention is achieved. A polyvinyl acetyral adhesive is obtained by adding an aldehyde to a polyvinyl alcohol aqueous solution first, and optionally adding a catalyst in the polyvinyl alcohol aqueous solution for a faster reaction rate and complete conversion. The aldehyde used herein may be glyoxal, with a content of, for example, about 0.01% to about 5% by weight. The concentration of the polyvinyl alcohol aqueous solution may be about 1% to 10% by weight. The polyvinyl acetyral adhesive is useful for attaching a PVA film to a TAC film in a polarizer fabrication process. The adhesive of the present invention may prevent the polyvinyl alcohol film from shrinking to avoid the detachment of the polyvinyl alcohol film at the edges of polarizers. Furthermore, using the adhesive according to the present invention may improve the weather resistance of the polarizer by providing good water and heat resistance thereto.

It is to be understood that both the foregoing general description and the following detailed description are examples, and are intended to provide further explanation of the invention as claimed.

### BRIEF DESCRIPTION OF THE DRAWINGS

The file of this patent contains at least one drawing executed in color. Copies of this patent with color drawing(s) will be provided by the Patent and Trademark Office upon request and payment of the necessary fee.

The invention can be more fully understood by reading the following detailed description of the preferred embodiment, with reference made to the accompanying drawings as follows:

FIG. 1 is a cross-sectional view of the structure of a polarizer;

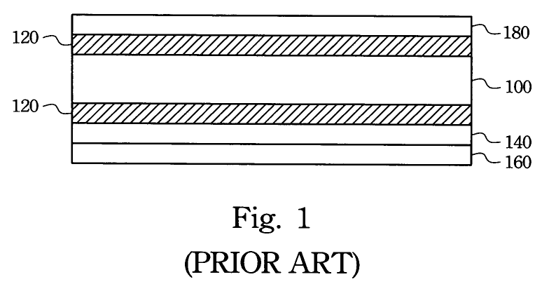

FIG. 2 is a flow chart illustrating steps of a method for producing an adhesive according to an embodiment of the present invention, and a water resistance test for the adhesive;

FIGS. 3A-3B are photographs illustrating the results of a water resistance test according to an embodiment of the present invention; and

FIGS. 4A-4B are photographs illustrating the results of a water resistance test of a control embodiment.

### DESCRIPTION OF THE PREFERRED EMBODIMENTS

All the preferred embodiments of the invention will now be described in detail and illustrated in the accompanying drawings, to illustrate production methods, uses and properties of an adhesive according to the present invention.

Wherever possible, the same reference numbers are used in the drawings and the description to refer to the same or like parts.

### Embodiment 1

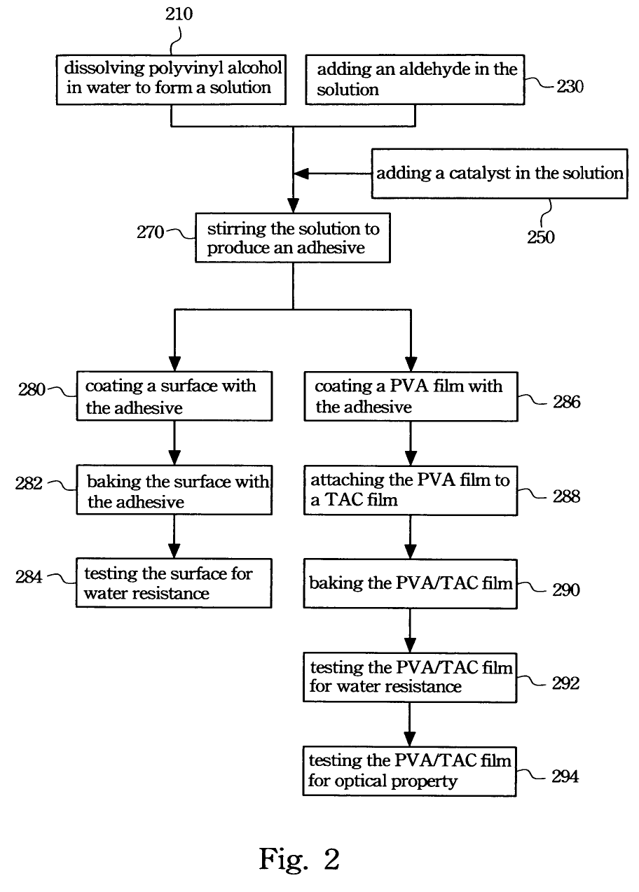

FIG. 2 is a flow chart illustrating a method for producing an adhesive according to an embodiment of the present invention. In step 210 and 230, polyvinyl alcohol (PVA) was dissolved in water to obtain a polyvinyl alcohol aqueous solution, and an aldehyde was then added to the polyvinyl alcohol aqueous solution. The aqueous solution was stirred to obtain a polyvinyl acetal in step 270. The aldehyde used herein may be formaldehyde, butyraldehyde, or glyoxal, and glyoxal was selected for Embodiment 1.

Furthermore, according to step 250, a catalyst was added to the polyvinyl alcohol aqueous solution for a faster reaction rate and complete conversion.

Because the aldehyde may color the polyvinyl alcohol aqueous solution yellow, adding too much aldehyde will affect optical properties of the adhensive according to the present invention. Thus, the preferred glyoxal content is about 0.01% to about 5% by weight, and the preferred concentration of the polyvinyl alcohol aqueous solution is about 1% to about 10% by weight. In addition, an acid is used as a catalyst herein for adjusting the pH value of the polyvinyl alcohol aqueous solution to between about 2 and about 7.

### Embodiment 2

Also referring to FIG. 2, the adhesive according to example of the present invention was obtained after finishing steps 210-270. The following step 280 was to apply the adhesive obtained in embodiment 1 to a surface. Step 282 was to bake the surface with an adhesive coating to vaporize the solvent in the adhesive, and the surface with an adhesive coating was ready for tests.

Step 284 was performed for testing water resistance of the adhesive coating on the surface. In step 284, the surface with the adhesive coating was immersed in water, boiled at 90° C. for 30 min, and baked at 90° C. for 24 hours for drying. After step 284, the surface with the adhesive coating was measured for weight loss to evaluate water resistance of the adhesive. In the test, the adhesive obtained in embodiment 1 had a weight loss less than 10%.

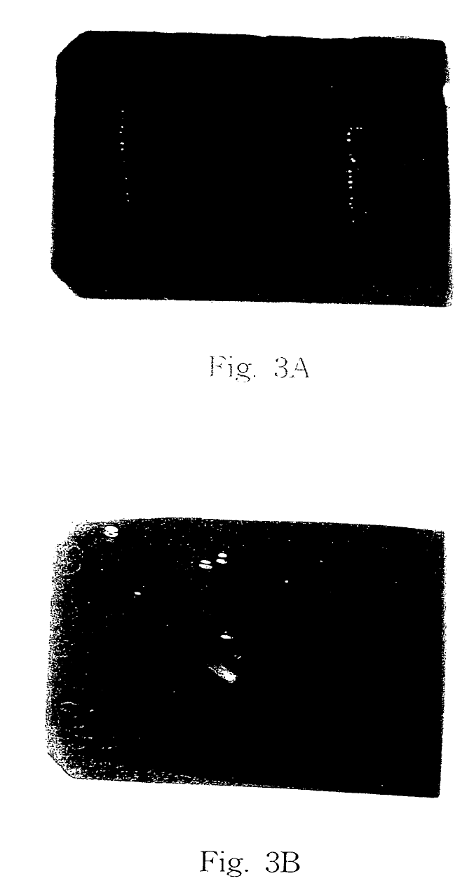

Next, the adhesive obtained in embodiment 1 was applied in a polarizer fabricating process. The polarizer made by using the adhesive in embodiment 1 was tested for water, heat, and weather resistance. As shown in FIG. 2, the adhesive obtained in step 270 was applied on a PVA film in step 286. Then, a TAC film was tightly attached to the PVA film to obtain a polarizer. The polarizer (PVA/TAC film) was baked to dry the adhesive between the two films (step 290). In step 292, the baked polarizer was immersed in water at 20° C. and 50° C. and observed as shown in FIGS. 3A and 3B, respectively. The integrity of the edge of the polarizer was preserved, and the films did not detach in water.

Furthermore, to determine the optical properties, such as transmittance of light, polarization, and light fastness, the polarizer was tested for 1000 hours under the following testing conditions: 80° C.; 60° C., and 90% relative humidity; 40° C., and 95% relative humidity; and exposure to a 400 W mercury lamp at a distance of 30 cm.

In the foregoing tests, the adhesive according to the preferred embodiment showed good water, heat, and weather resistance, and the polarizer made with the adhesive of the preferred embodiment had stable optical properties (the variation of the optical properties was less than 3%).

### Embodiment 3 (Control Embodiment)

Still referring to FIG. 2, conventional glue was used as a control by following steps 280-284, and then was tested for water resistance in comparison with the adhesive obtained in embodiment 1. The conventional glue applied on a surface was almost loss in the water resistance test.

A control polarizer was produced by using the conventional glue and following the same method described in embodiment 2, i.e. attaching a PVA film to a TAC film by using the conventional glue. Then the control polarizer was tested for water and weather resistance in the same conditions described above.

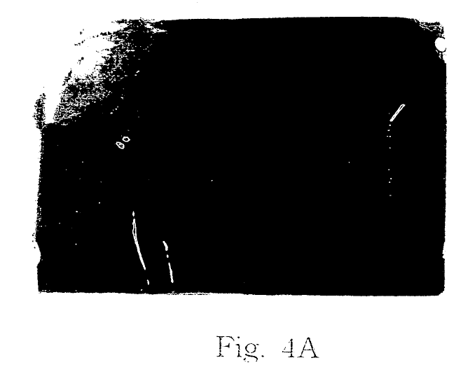

Compared with the polarizer of embodiment 2, the TAC film of the edges of the control polarizer was detached from the PVA film after the test. FIG. 4A and 4B show the TAC film shrinking and detaching from the control polarizer when the polarizer was immersed in 20° C. and 50° C. water, respectively. Besides, the control polarizer produced by using conventional glue had a variation of optical properties greater than 3%, and was unstable in quality.

According to the foregoing, the adhesive according to the present invention has better water resistance than conventional glue, and is sufficient for adhesion between PVA film and TAC film. Using the adhesive according to the present invention may avoid detachment at the edges of polarizers, and thus may improve the yield of polarizers. Furthermore, the adhesive according to the present invention has relatively good water and heat resistance; therefore a polarizer produced by using the adhesive of the present invention may have a better weather resistance.

It will be apparent to those skilled in the art that various modifications and variations can be made without departing from the scope or spirit of the invention. In view of the foregoing, it is intended that the present invention cover modifications and variations of this invention provided they fall within the scope of the following claims and their equivalents.

What is claimed is:

1. An adhesive for a polarizer, comprising:
a polyvinyl alcohol aqueous solution; and
an aldehyde dissolved in the polyvinyl alcohol aqueous solution.

2. The adhesive of claim 1, further comprising a catalyst added to the polyvinyl alcohol aqueous solution.

3. The adhesive of claim 2, wherein the catalyst is an acid.

4. The adhesive of claim 3, wherein the acid is added in an amount for adjusting the polyvinyl alcohol aqueous solution to a pH value between about 2 and about 7.

5. The adhesive of claim 1, wherein a concentration of the polyvinyl alcohol aqueous solution is about 1% to about 10% by weight.

6. The adhesive of claim 1, wherein the aldehyde is formaldehyde, butyraldehyde, or glyoxal.

7. The adhesive of claim 1, wherein the aldehyde is glyoxal.

8. The adhesive of claim 7, wherein the glyoxal content is about 0.01% to about 5% by weight.

9. An adhesive for a polarizer, comprising:
a polyvinyl alcohol aqueous solution;
an aldehyde added to the polyvinyl alcohol aqueous solution; and
a catalyst added to the polyvinyl alcohol aqueous solution.

10. The adhesive of claim 8, wherein the catalyst is an acid.

11. The adhesive of claim 10, wherein the acid is added in an amount for adjusting the polyvinyl alcohol aqueous solution to a pH value between about 2 and about 7.

12. The adhesive of claim 9, wherein a concentration of the polyvinyl alcohol aqueous solution is about 1% to about 10% by weight.

13. The adhesive of claim 9, wherein the aldehyde is formaldehyde, butyraldehyde, or glyoxal.

14. The adhesive of claim 9, wherein the aldehyde is glyoxal.

15. The adhesive of claim 14, wherein the glyoxal content is about 0.01% to about 5% by weight.

16. An adhesive for a polarizer adhesion, comprising:
a polyvinyl alcohol aqueous solution;
a glyoxal added to the polyvinyl alcohol aqueous solution; and
an acidic catalyst added to the polyvinyl alcohol aqueous solution.

17. The adhesive of claim 16, wherein a concentration of the polyvinyl alcohol aqueous solution is about 1% to about 10% by weight.

18. The adhesive of claim 16, wherein the glyoxal content is about 0.01% to about 5% by weight.

19. The adhesive of claim 16, wherein the acidic catalyst is added in an amount for adjusting the polyvinyl alcohol aqueous solution to a pH value between about 2 and 7.
